(19) United States
(12) Patent Application Publication
(10) Pub. No.: US 2006/0233395 A1
(43) Pub. Date: Oct. 19, 2006

(54) Sound effects microphone

(76) Inventor: Birger Orten, Alesund (NO)

Correspondence Address: LADAS & PARRY LLP, 224 SOUTH MICHIGAN AVENUE, SUITE 1600, CHICAGO, IL, 60604, US

(21) Appl. No.: 10/497,829

(22) PCT Filed: Nov. 26, 2002
(86) PCT No.: PCT/NO02/00443

§ 371 Date: Sep. 20, 2004

(30) Foreign Application Priority Data
Dec. 6, 2001 (NO) 20015983

(51) Int. Cl. H04R 3/00

(52) U.S. Cl. 381/122

(57) ABSTRACT

A song microphone (1) comprises a microphone house (5) which also forms a gripping part, an acousto-electric transducer (7) in a foremost part of the house for receiving sound from a sound source, and equipment (2, 14, 15) for transmission of sound-representing signals from the transducer (7), out through the microphone (1) and to external audio signal processing equipment. The signal processor equipment (9) is arranged in or on the house (5). The signal processor equipment (9) may contain audio signal processing equipment in the form of a frequency/voice modulator, AID-transformer and digital circuits, together with memory circuits for storing processing algorithms for audio signals. The signal processor equipment (9) may also contain control-signal processing equipment.

The present invention concerns a song microphone comprising a microphone housing that also constitutes a gripping part, an acoustoelectric transducer in a forward part of the housing for receiving sound from a sound emitter, and equipment for transfer of sound-representing signals (sound signals) from the transducer, out of the microphone and to external sound signal processing equipment.

Especially in connection with microphones included in hearing aids, but also in connection with built-in microphones in mobile phones and similar, it is a relatively common feature that signal processing equipment is incorporated in the same unit in order to process the sound signals that represent sound picked up by the microphone, in accordance with various algorithms and for various purposes. For instance in hearing aids, built-in amplification is an obvious feature, but additionally there are numerous other subtle processing features to ensure that the sound that is directed into the users auditory canal, will be perceived as natural and comfortable sound.

As regards mobile phones, in part extreme calculating operations are executed on the sound signals representing the sound that has been picked up, prior to transmission of processed signals “on the air”. The signal processing may for instance comprise digitizing, encoding, noise cancellation, echo cancellation etc.

From British patent application GB 2288054 A is previously known a wireless “karaoke microphone” with built-in processor equipment. However, this processor equipment is included only to produce accompanying music, and this previously known microphone does nothing regarding the actual microphone sound that is transmitted from the microphone, the only thing that happens, is that music is added “next to” the song sound.

The microphone type that is used for music or PA-purposes, for instance by an artist on a stage, has until now been of a relatively simple character, since it has been regarded as most natural, for such purposes, to use sound processing equipment in connection with for instance a master control constituting part of the total amplifier/PA-equipment, at a distance from the actual microphone. Certainly, it has been relatively normal for some years now with a built-in radio transmitter in so-called wireless microphones, but this has been limited to the type of signal processing dealing with the radio transmission. In the present text, signal treatment/signal processing is intended to mean actual influence on the sound-representing signals, i.e. for example cancellation of noise or echo, frequency equalization/influence, added special effects, for instance special distortion programs or similar.

An artist will often desire better control regarding the sound reproduction than what can be offered in ordinary song microphones. A “personal” microphone containing options for sound management and control, possibly also with special effects that the artist himself/herself is in complete command of, would seem to represent a remaining need.

The present invention aims at fulfilling just such a need, and hence, there is provided, in accordance with the invention, a song microphone such as defined in the introduction, and the song microphone in accordance with the invention is characterized in that signal processor equipment is arranged in or on the microphone housing.

In a preferred embodiment, the signal processor equipment includes sound signal processing equipment. The sound signal processing equipment may comprise a frequency/voice modulator, and it may also comprise an A/D converter and digital circuitry. Further, the sound signal processing equipment may comprise memory circuitry for storing processing algorithms for sound signals.

In one embodiment, the signal processor equipment may comprise at least one station for receiving a data memory unit.

In another preferred embodiment, the signal processor equipment includes control signal processing equipment. This control signal processing equipment may comprise circuitry for communication, processing and storage of data regarding control of sound processing equipment included in the microphone. Furthermore, the control signal processing equipment may comprise memory circuitry for storing processing algorithms for sound signals, preferably on a digital form.

In the following, the invention shall be illuminated further by discussing exemplary embodiments, and in this connection it is referred to the appended drawings, of which

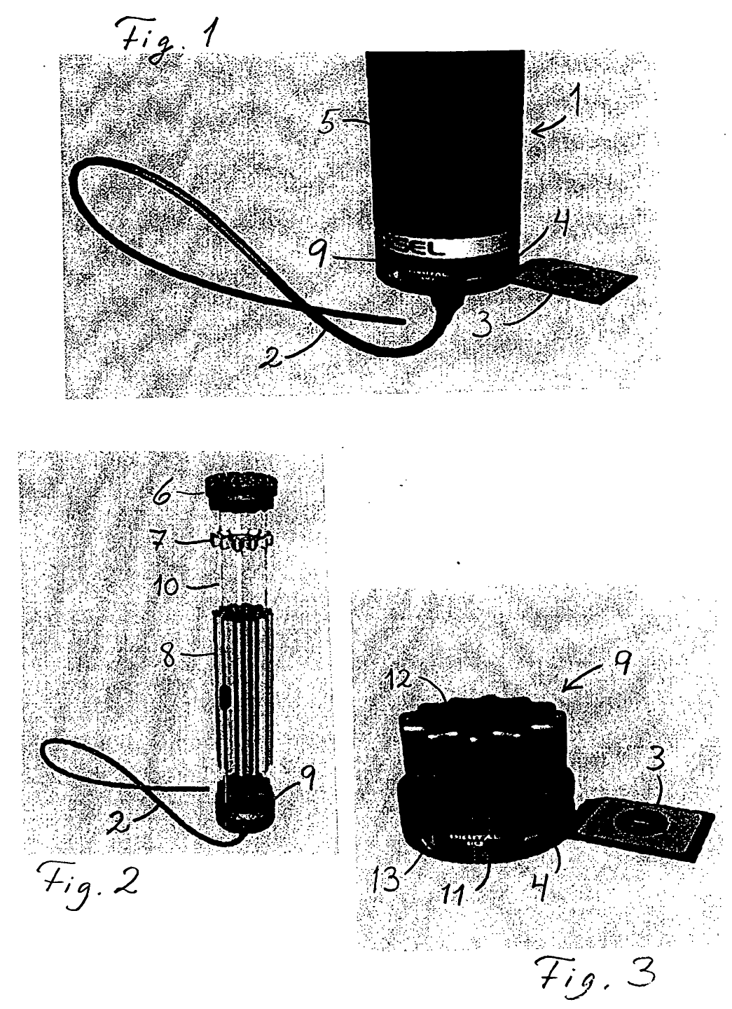

FIG. 1 shows the lower part of a normal, hand-held song microphone, however with signal processor equipment provided at the lower end,

FIG. 2 shows the inner parts of a microphone in accordance with an embodiment of the invention, including a lower part with signal processor equipment,

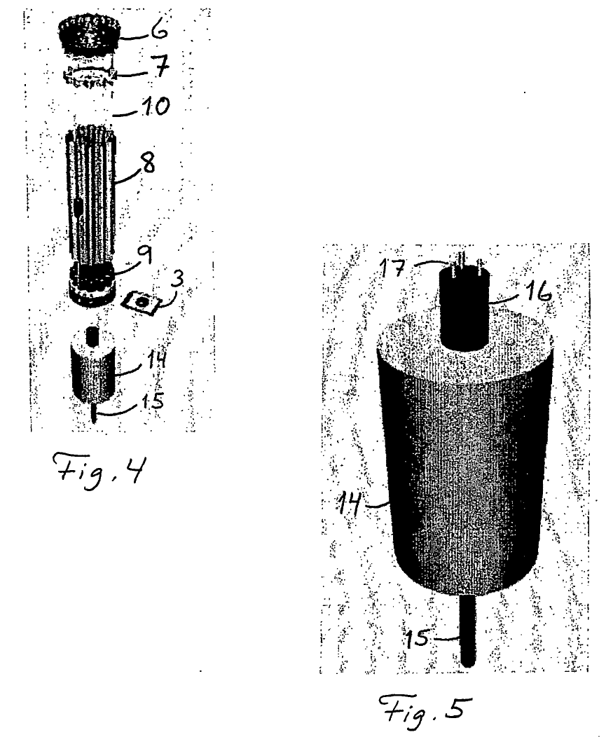

FIG. 3 shows a base part of a microphone in accordance with an embodiment of the invention, the base part comprising signal processor equipment,

FIG. 4 shows inner parts of a microphone in the same manner as FIG. 2, but in a wireless microphone embodiment, and

FIG. 5 shows the radio unit included in FIG. 4, in an enlarged view.

In FIG. 1 appears the lower part of a hand-held song microphone 1, of a type with a wire 2 carrying sound-representing signals to external equipment that comprises amplifiers and similar apparatus. The wire 2 may just as well be replaced by a special radio transmitter unit with an antenna. Reference numeral 5 designates a microphone housing, and reference numeral 9 designates a unit mounted at the lower end of the microphone, this unit containing signal processor equipment. The figure also shows that unit 9 has a slot 4, into which it is possible to insert an external memory card 3.

In FIG. 2 appears a similar microphone in an “undressed” state, i.e. the microphone housing 5 has been removed. Thus, from the figure appears a front grille or microphone top 6, sound transducer equipment arranged thereunder for picking up and converting sound pressure to electrical signals, further stays 10 supporting the structure, a sleeve 8 which is not of special importance in the present invention, but which is discussed in co-filed Norwegian patent application No. 2001 5982 from the same applicant, and finally the lower unit 9 that contains signal processor equipment.

FIG. 3 shows the lower unit 9 in an enlarged view and alone, and it appears that this unit is constructed with a top part 12 that is adapted to the other structures in the microphone, and which constitutes a compartment for circuitry devices, and a lower socket 11 having a slot 4 for receiving a memory card 3, as well as a connector opening 13 for receiving a data plug.

The base unit 9 may comprise signal processor equipment for direct treatment of sound signals, but also signal processor equipment for treating control signals that in their turn are intended to bring about control for sound processing equipment of the type that has been mentioned above and that is included in base unit 9.

The base unit 9 thus contains a microprocessor, preferably a programmable microprocessor. This microprocessor may have algorithms that have been programmed in advance for achieving special effects that may possibly be selected using a (not shown) operating button. Further, the processor may be programmable, for instance in such a manner that it can be made subject of programming through connection to an external computer by means of connector 13. For the rest, the circuitry inside base unit 9 may contain memory circuits for storing processing algorithms for sound signals, and there is also a possibility to make such a storage device store for example a song performed by the artist. Data storage can be made also in insertable memory cards 3 entered in slit 4.

Among the special effects that can be stored, is for instance a frequency modulator or voice modulator for providing a distorted voice, echo effects are of course possible, and it will even be possible to program voice and frequency corrections for adjusting the voice of the artist in difficult situations. Even a “look-alike” function, i.e. algorithms for imitating certain voice types, can be programmed in. Ordinary “equalizing”, i.e. influencing certain frequency ranges by amplification or attenuation, can of course also be achieved, even very precise equalization, attacking very narrow frequency ranges.

Preferably, the sound signal processing equipment is based on digital processor technology, meaning that an A/D converter must be included in the equipment for converting the analogue sound-representing signals delivered by sound transducer 7. In principle, execution of the topical functions in an analogue manner represents no problem, but present technology regarding digital circuitry and digital signal processing is developed and miniaturized to such a degree that this technology is preferable. However, in order to provide a “bridge” back to normal, analogue external equipment, one may readily include also a built-in D/A converter for reverse conversion, after signal processing, of the digital signals to analogue signals.

The complete base part 9 is exchangeable, so a set of such base parts 9 may be included in a microphone kit. Every base part may then be pre-programmed from a PC via the connector opening 13. Possibly, and as mentioned above, memory cards 3, for instance of the “Smart Disc” type, may provide further options for data storage.

Thus, settings regarding programmable parameters may cancel for example breathing noise and undesired sound peaks, and emphasize desired harmonies or special voice features. Frequency response and dB response can be adjusted. A simple communication with a PC is achieved, as well as storage capacity for personal settings.

FIG. 4 shows an embodiment in which the microphone is of the wireless type. The remaining elements in the figure is just as described regarding FIG. 2, but at the bottom end appears a radio unit 14 with antenna 15. The radio unit 14 is intended to be snapped simply and quickly into place upward into the base module 9, which base module contains the processor equipment.

FIG. 5 shows an enlarged view of the radio unit 14, in order to provide an improved view of contact pins 17 on a plug 16 designed to be snapped fixedly, but releasably into a corresponding connector opening at the underside of base module 9. Data/signal communication is established between the processor equipment in module 9 and radio unit 14 for transmission of radio signals of digital or analogue type. Nothing is in the way of including also a microprocessor for various types of signal processing, in the radio unit.

As a starting point, the radio unit 14 is adapted for transmission of sound-representing radio signals, and possibly certain control signals, to an external equipment. There are options for programming the circuits of the base module, or of the processor in the radio unit, to radio operation at a number of different frequencies within the allowed frequency range for this type of radio transmission. Changes can be made by pre-programming from a PC for example, or by insertion of a memory card 3 in the base module 9 on the spot.

In an advanced embodiment of the microphone in accordance with the invention, it can be used in an internal communication network between a plurality of such microphones. In this case, the radio unit 14 then has the capability both of transmission and reception. Technically, this can be implemented in a simple manner, and the possibility arises then, that for instance one of the microphones is established as a “master” microphone, while the other microphones are “slaves”. An algorithm or a command desired to be valid for the slaves, can then be transmitted from the master microphone, for instance by inserting a special memory card in the base module, or by equipping the master microphone with a special operating switch. It may for example be of interest to ascertain that some microphones do not make any transmission in certain periods, inter alia to avoid noise, or it may be of interest to change certain programmable characteristics of some microphones in use. A leader having such a master microphone is then able to control the characteristics of a plurality of microphones. A lot of what is intended to be executed of such changes during a session, can be programmed in advance in the respective microphones, so that the signalling that is made, can be very simple.

Finally, it shall be mentioned that the present invention is one among several inventions regarding a complete microphone, which inventions have all been made the subject of co-filed patent applications. It is referred to Norwegian patent application No. 2001 5982 regarding “A microphone with ventilation”, Norwegian patent application No. 2001 5985 regarding “A microphone with ranging”, and Norwegian patent application No. 2001 5984 regarding “A song microphone having exchangeable identity details”. To the degree in which these co-filed applications exhibit features suitable to explain or complete features of the present invention, these applications are hereby incorporated in the present specification by reference.

1. A song microphone comprising a microphone housing which also constitutes a gripping part, an acoustoelectric transducer in a forward part of the housing for receiving sound from a sound emitter, and equipment for transfer of sound-representing signals (sound signals) from the transducer, out of the microphone and to external sound signal processing equipment,
characterized in that signal processor equipment is arranged in or on said housing.

2. The song microphone of claim 1,
characterized in that said signal processor equipment includes sound signal processing equipment.

3. The song microphone of claim 2,
characterized in that said sound signal processing equipment includes a frequency/voice modulator.

4. The song microphone of claim 2,
characterized in that said sound signal processing equipment includes an A/D converter and digital circuitry.

5. The song microphone of claim 2,
characterized in that said sound signal processing equipment includes memory circuits for storage of processing algorithms for sound signals.

6. The song microphone of claim 1,
characterized in that said signal processor equipment includes at least one station for receiving a data storage unit.

7. The song microphone of claim 1,
characterized in that said signal processor equipment includes control signal processing equipment.

8. The song microphone of claim 7,
characterized in that said control signal processing equipment includes circuits for communication, processing and storage of data regarding control of sound processing equipment included in the microphone.

9. The song microphone of claim 7,
characterized in that said control signal processing equipment includes memory circuitry for storage of processing algorithms for sound signals, preferably on a digital form.

10. The song microphone of claim 1,
characterized in that said signal processor equipment is contained in a module that is exchangeable in a simple manner, and preferably arranged as a rear part of the microphone housing.

11. The song microphone of claim 1,
characterized in that said signal processor equipment is contained in a module having a connector for quick coupling to a radio unit with an antenna, which radio unit can be easily snapped on, for use of the microphone as a wireless microphone.

12. The song microphone of claim 11,
characterized in that said radio unit or signal processor equipment can be programmed for radio operation at various frequencies.

13. The song microphone of claim 11,
characterized in that said radio unit is a two-way unit, and that the radio unit or the signal processor equipment has a master function, thereby to be able to transmit a stored and desired control algorithm, or an order regarding implementation of such an algorithm, wirelessly to at least one other similar microphone that has been put into a slave function.

14. The song microphone of claim 11,
characterized in that said radio unit is a two-way radio unit, and that the radio unit or the signal processor equipment has a slave function, thereby to be able to receive control algorithms, or orders regarding implementation of such algorithms, wirelessly from a similar microphone that has been provided with a master function.
